(19) United States
(12) Patent Application Publication
(10) Pub. No.: US 2004/0003734 A1
(43) Pub. Date: Jan. 8, 2004

(54) Method and apparatus for printing using an electrically conductive ink

(76) Inventors: J. Thomas Shively, Hinsdale, IL (US); Did Bun Wong, Glen Ellyn, IL (US)

Correspondence Address: MCCRACKEN AND FRANK, 200 W. ADAMS STREET, SUITE 2150, CHICAGO, IL, 60606, US

(21) Appl. No.: 10/187,874

(22) Filed: Jul. 2, 2002

(51) Int. Cl. B05D 1/36

(52) U.S. Cl. 101/327

(57) ABSTRACT

A method of printing using an electrically conductive ink, wherein the method includes the steps of providing a supply of the electrically conductive ink and providing a relief printing plate having a desired printing pattern formed thereon. The pattern includes at least two adjacent traces having a gap between the adjacent traces of less than about 40 microns and, optionally, at least one trace having a width of less than about 40 microns. The method further includes the steps of applying a controlled quantity of the electrically conductive ink to the relief printing plate and contacting the relief printing plate to a substrate to create an impression on the substrate. An apparatus for implementing the method is also disclosed.

### TECHNICAL FIELD

The present invention relates to printing electrically conductive inks, and more particularly, to a method and apparatus for printing electrically conductive inks in traces in close proximity to one another and having narrow widths.

### BACKGROUND ART

The concept of directly printing the components of electrical circuits directly onto a substrate is well known. For example, Brand et al. U.S. Pat. No. 3,652,332 describes methods for direct printing of conductors, resistors and dielectrics using a conventional letterpress printing process.

Recently, researchers have developed methods to apply liquid semiconductors to a substrate, thus enabling the creation of directly printed diodes and field effect transistors. The performance of these components is strongly impacted by both the carrier mobility of the semiconductor and the ratio of the width to length (W/L) of the channel between the source and drain electrodes. The ability to print conductive traces in very close proximity to one another is important to the performance of the resulting component and the minimum width at which the traces can be consistently reproduced determines the maximum density at which the components can be packed onto a substrate.

One method of printing conductive traces in close proximity to each other is a technique pioneered by George Whitesides and his colleagues at Harvard University termed “microcontact printing,” which utilizes a stamp which is inked for several minutes. The inked stamp is then brought into contact with the substrate to form an impression and then the same inked stamp is used again a few times before re-inking is required (Brittain, S., Kateri, P., Zhao, Xiao-Mei, and Whitesides, G. “Soft Lithography and Microfabrication.” Physics World (May 1998)). However, this technique is very slow and not suitable for large-scale commercial applications.

An article entitled “A Novel Circuit Fabrication Technique Using Offset Lithography” (Ramsey, B. J., P.S.A. Evans and D. Harrison. Journal of Electronics Manufacturing, Vol. 7, No. 1, March 1997) discloses the use of an offset lithographic method, wherein the resolution limits of the method are stated to lie between 10 and 100 microns. While lines of 10 microns are disclosed, these lines do not conduct electricity. A track or gap width of 100 microns is necessary for reliable conductivity. See also related PCT publication WO 97/48257.

### SUMMARY OF THE INVENTION

In accordance with one aspect of the present invention, a method of printing using an electrically conductive ink includes the steps of providing a supply of the electrically conductive ink and providing a relief printing plate having a desired printing pattern formed thereon. The pattern includes two adjacent traces having a gap between the adjacent traces of less than about 40 microns. The method further includes the steps of applying a controlled quantity of the electrically conductive ink to the relief printing plate and contacting the relief printing plate to a substrate to create an impression on the substrate.

In accordance with another aspect of the present invention, a method of printing using an electrically conductive ink includes the steps of providing a supply of electrically conductive ink and providing a relief printing plate having a desired printing pattern formed thereon. The pattern also includes two adjacent traces having a gap between the adjacent traces of less than about 40 microns and at least one trace having a width of less than about 40 microns. The method further includes the steps of applying a controlled quantity of the electrically conductive ink to the relief printing plate and contacting the relief plate to a substrate at a print speed of greater than about 3,000 impressions per hour.

In accordance with yet another aspect of the present invention, an apparatus for printing electrically conductive ink includes a relief printing plate having a desired printing pattern formed thereon, wherein the pattern includes two adjacent traces having a gap between the adjacent traces of less than about 40 microns. The apparatus further includes an ink train that applies a controlled quantity of the electrically conductive ink to the relief printing plate, wherein the relief printing plate contacts a substrate to create an impression on the substrate.

Other aspects and advantages of the present invention will become apparent upon consideration of the following detailed description.

### BRIEF DESCRIPTION OF THE DRAWINGS

FIG. 1 is a side elevational view of a first field effect transistor (FET) that can be produced in accordance with the present invention;

FIG. 2 is a plan view of the FET of FIG. 1;

FIG. 3 is a plan view of a second FET produced in accordance with the present invention;

FIG. 4 is a schematic representation of a press that implements a first method for printing electrically conductive inks according to the present invention;

FIG. 5 is a schematic representation of a press that implements a second method for printing electrically conductive inks according to the present invention; and

FIG. 6 is a schematic representation of a press that implements a third method for printing electrically conductive inks according to the present invention.

### DESCRIPTION OF THE PREFERRED EMBODIMENTS

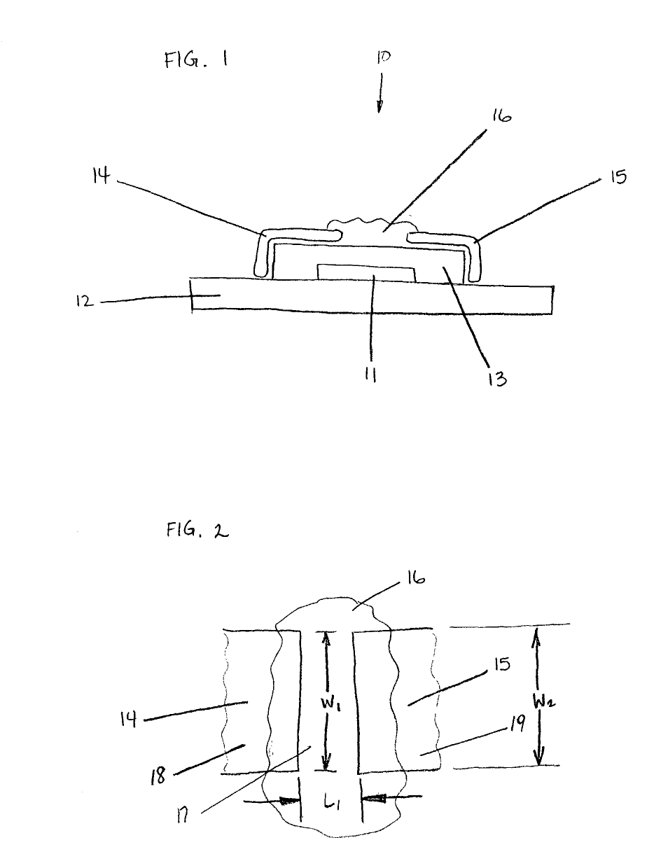

The method and apparatus for printing of the present invention can be used to create a source electrode and a drain electrode of a field effect transistor (FET). Referring first to FIGS. 1 and 2, an embodiment of an FET 10 includes a first gate layer 11 placed on a substrate 12, wherein the gate layer 11 is made of a conductive material. The gate layer 11 can be printed using any conventional printing process, such as screen printing, pad printing, offset lithography, flexographic printing or gravure printing. Alternatively, the gate layer 11 can be printed using the method of the present invention, as described hereinafter. Whatever printing process is utilized, the gate layer 11 should be printed with at least a minimum degree of accuracy. A dielectric material 13 is positioned on top of and covering the gate layer 11. The dielectric material 13 is printed on the gate layer 11 by any conventional printing process, such as screen printing, pad printing, offset lithography or flexographic printing. In addition, the dielectric material 13 may be printed by the method of the present invention. In the case of the dielectric material 13, the printing need not be extremely precise, but it is important that the dielectric does not have any holes or voids formed therein. A source electrode 14 and a drain electrode 15 are printed on opposite sides of the dielectric material 13, wherein a small gap 17 is disposed between the source electrode 14 and the drain electrode 15. The source electrode 14 and the drain electrode 15 can take different shapes. Interconnecting the source electrode 14 and the drain electrode 15 of the transistor 10 is a semiconductor material 16. The semiconductor material 16 is printed using any conventional printing process, such as flexographic printing, pad printing, inkjet printing or screen printing. The method of the present invention may also be used to print the semiconductor material 16.

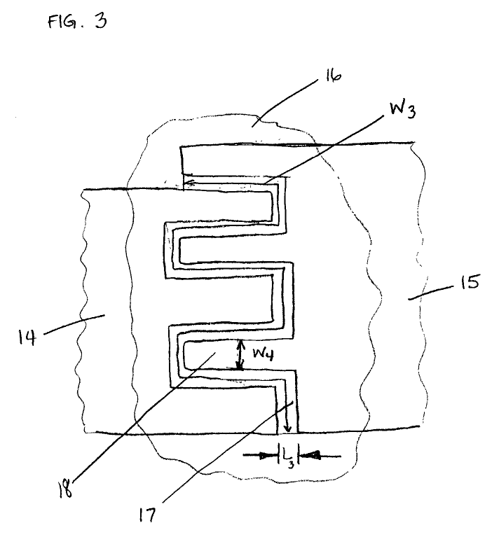

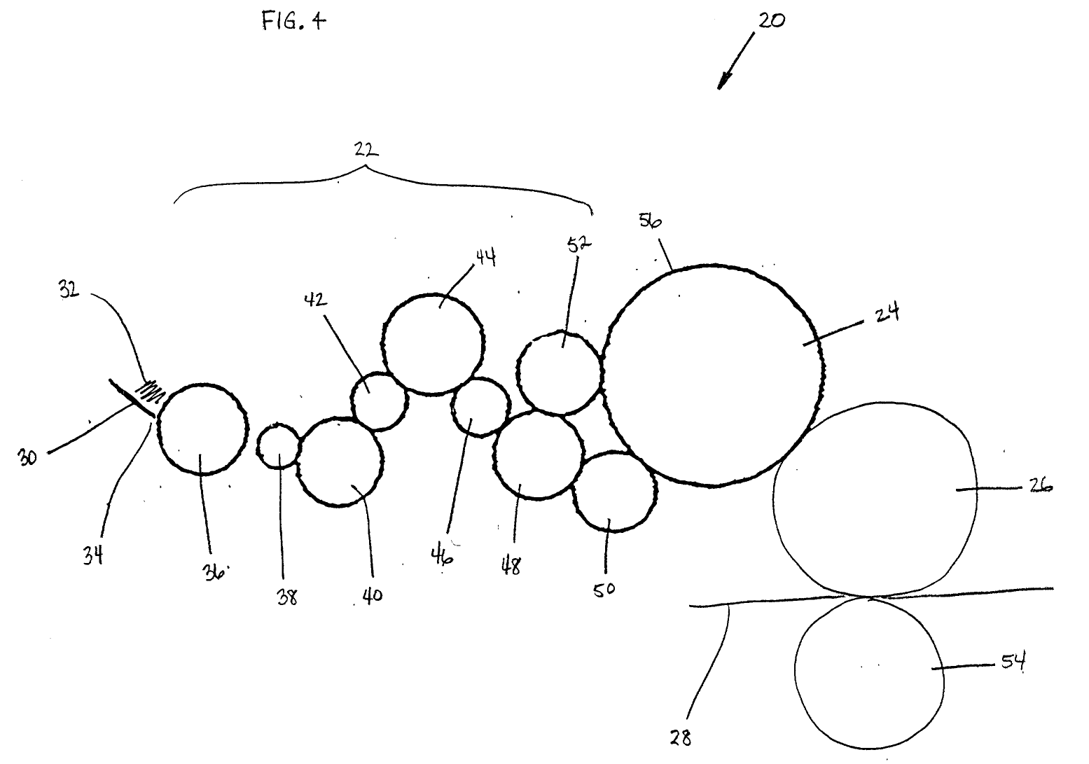

As seen in FIG. 2, each of the source electrode 14 and the drain electrode 15 comprises traces having rectangular ends in part defined by linear end margins 18 and 19. The end margins 18 and 19 are parallel to one another to define the gap 17 having a substantially constant gap length L1 and gap width W1. It is necessary to print the source electrode 14 and the drain electrode 15 with high precision. Often, it is necessary to maintain a ratio of the gap width W1 to the gap length L1 on the order of 100. The method and apparatus of the present invention can be used to print traces defining a gap length L1 of less than about 40 microns, and preferably less than 20 microns, thus necessitating a large value for the width W1. One way to achieve this ratio with an improved packing configuration is to print the source electrode 14 and the drain electrode 15 in zig-zag patterns such as in FIG. 3. The gap 17 of FIG. 3 has a length L3 and a width W3 that is measured along the centerline of the entire extent of the gap. Traces with widths W4 of less than 40 microns, and preferably less than 20 microns, can be printed by the method and apparatus of the present invention.

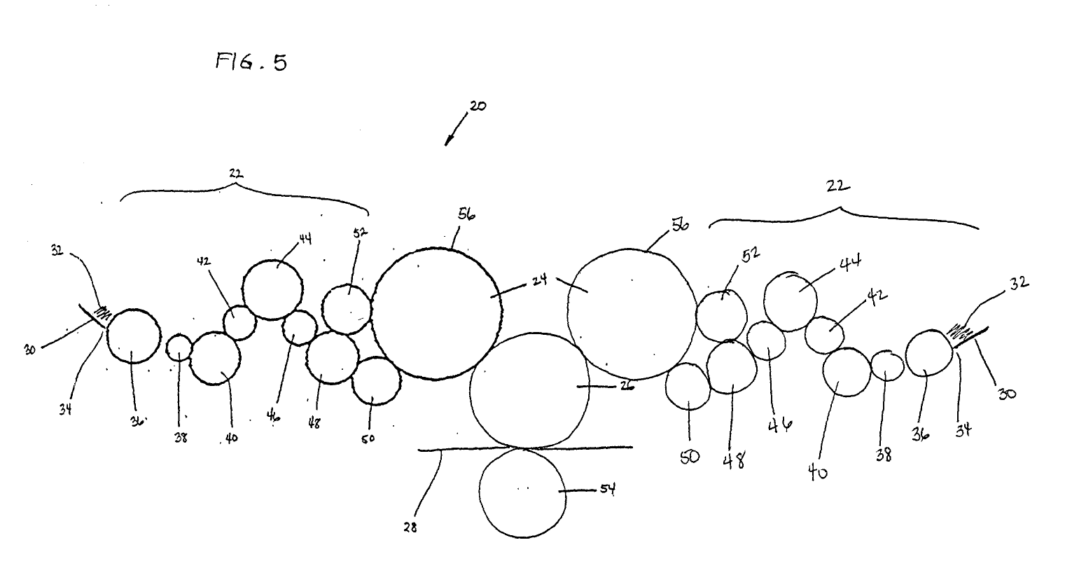

As seen in FIG. 4, a relief press 20 includes an ink train 22 containing several rollers leading to an inking cylinder 24 and a relief printing plate 26. In the relief press 20, the inking cylinder 24 has been treated to accept ink over its entire surface and the relief printing plate 26 is formed with elevated and recessed areas using conventional means and used to print an image directly onto a substrate 28.

The method of the present invention as seen in FIG. 4 includes the steps of filling an ink fountain 30 with an ink 32 and applying the ink 32 through an adjustable gap 34 in the ink fountain 30 to an ink fountain roller 36 to create a uniformly thick layer of the ink 32 on the ink fountain roller 36. A set of ink keys (not shown) is used to adjust the gap 34 to determine the thickness of the ink layer to be distributed at each point along the length of the fountain roller 36. The method further includes the steps of rotating the ink fountain roller 36 with the ink 32 carried thereby and transferring the ink 32 from the ink fountain roller 36 to an ink doctor roller 38. The doctor roller 38 moves back and forth between the ink fountain roller 36 and an ink distributor roller 40 in order to transfer ink to the latter. The length of time that the doctor roller 38 is brought into contact with the ink fountain roller 36 and the ink distributor roller 40 and the frequency at which the doctor roller 38 moves between the rollers 36 and 40 determine the amount and thickness of the ink 32 that is transferred to the ink distributor roller 40. The frequency at which the doctor roller 38 reciprocates is determined by how fast the relief press 20 is running and the length of time the roller 38 is in contact with the rollers 36 and 40 and can be adjusted using an electronic control for the relief press.

The method further includes the steps of transferring the ink 32 from the ink distributor roller 40 to a vibrating roller 44 by way of a transfer roller 42 and transferring the ink 32 from the vibrating roller 44 to first and second form rollers 50 and 52, respectively, by way of further transfer rollers 46 and 48. The chain of rollers from the distributor roller 32 to the form rollers 50 and 52 functions to smooth out irregularities in the ink 32 for later application to a substrate 28.

The method still further includes the steps of transferring the ink 32 from the form rollers 50 and 52 to the inking cylinder 24, wherein the number of form rollers can be increased or decreased depending on the amount and required uniformity of the ink 32 to be applied to the inking cylinder 24. An ink receptive sheath 56 is disposed about the surface of the inking cylinder 24, wherein the ink receptive sheath 56 is preferably a conventional lithographic printing plate. The particular type of ink receptive sheath 56 used is not important, so long as the sheath 56 can be treated so that it accepts ink over the entire surface thereof.

The method still further includes the step of applying a controlled quantity of the ink 32 at a controlled pressure of about 500 p.s.i. from the ink receptive sheath 56 to the relief printing plate 26. The relief printing plate 26 is made using any standard technique for creating letterpress, flexographic or polymer stamp printing plates. Typically, a film master is created, wherein the film master can be used to expose a photosensitive polymer to create a photopolymer plate or a photosensitive etch resist to create a metal plate. The film master could be produced using any conventional apparatus such as an imagesetter.

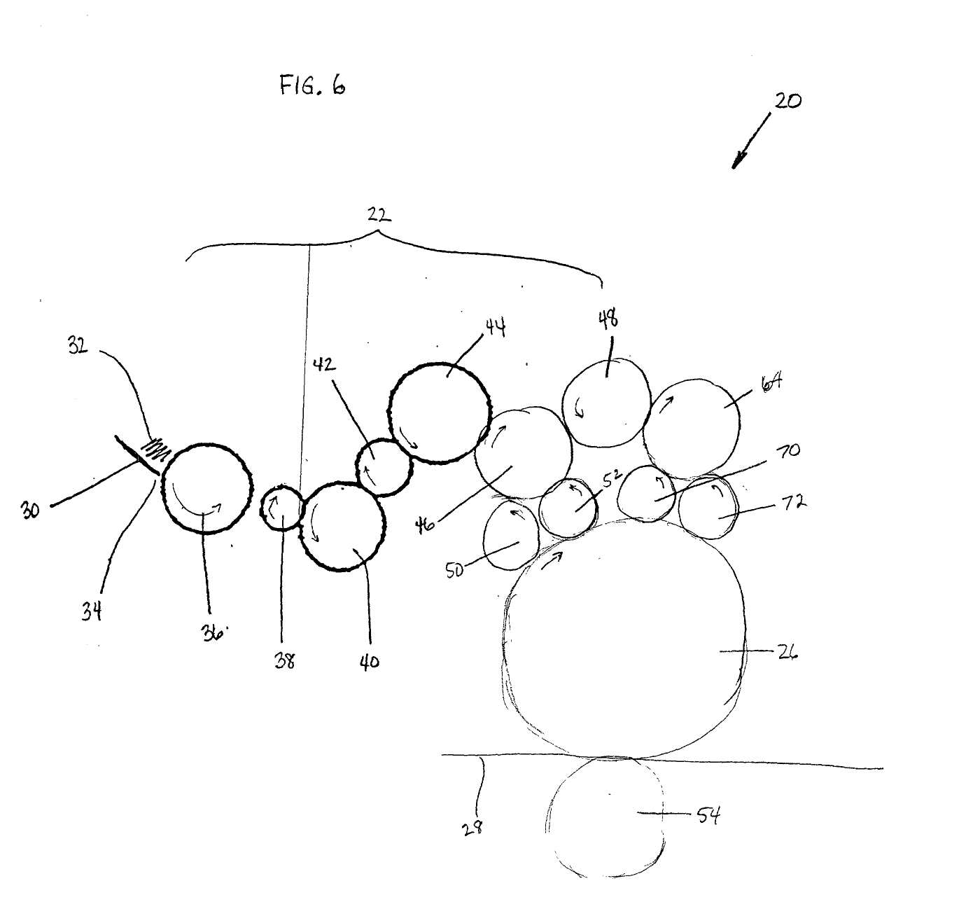

Multiple applications of the ink 32 to the relief printing plate 26 between successive impressions are preferable in order to attain the correct thickness of ink 32 on the relief printing plate 26. Usually, the preferred thickness of ink 32 on the relief printing plate 26 is from about 1.5 microns to about 4 microns. If it is necessary to transfer a thicker layer of ink to the substrate to increase the conductivity of the trace, the inking cylinder 24 can come into contact with the relief printing plate 26 two or more times before bringing the relief printing plate 26 into contact with the substrate. Specifically, the relief printing plate 26 is inked by rotating the inking cylinder 24 and applying ink to the relief printing plate 26 multiple times between impressions. As an alternative, the relief printing plate 26 can be inked by two or more inking cylinders 24 as shown in FIG. 5.

While it is possible to provide the desired thickness of ink on the relief printing plate 26 by inking the relief printing plate 26 with a single thick application of ink between impressions, it is preferred to build up the ink thickness on the relief printing plate 26 with multiple thin layers of ink 32 until the desired thickness of the ink 32 on the relief printing plate 26 is achieved. One reason for this is that a single thick application of the ink 32 can cause bleed over of the ink 32 from the raised areas of the relief printing plate 26 into the adjacent recesses. This bleeding can create shorts between adjacent traces in the printed circuit. It is believed that multiple thin applications of the ink 32 onto the relief printing plate 26 avoids bleeding into the recesses. In addition, applying multiple thin layers to the relief printing plate between impressions reduces the likelihood of broken or interrupted traces and can increase the conductivity of the printing on the substrate 28.

After the ink 32 is applied to the relief printing plate 26, the printing pattern or image that is on the relief printing plate 26 is transferred to a substrate 28 when the relief printing plate 26 contacts the substrate 28. An impression roller 54 is disposed on an opposite side of the substrate 28 from the relief printing plate 26. The impression roller 54 drives the substrate 28 into intimate contact with the relief printing plate 26 at a pressure of about 230 p.s.i. The viscosity of the ink 32 should be high enough to enable proper transfer of the ink 32 from roller to roller and the temperature should be controlled to maintain the necessary viscosity of the ink 32.

The relief printing plate 26 is then re-inked by the inking cylinder 24 the required number of times to build the required ink thickness and thereafter, the next substrate is printed. The overall printing process may proceed at a rate of greater than 3,000 impressions per hour. In fact, it is possible to achieve much greater print speeds and still maintain the ability to print narrow and closely packed conductive traces.

The thickness of the printed ink film should be enough to provide sufficient conductivity, but not so thick that ink film spread is a concern and subsequent processing of the substrate 28 is problematic. An ink or film thickness on the order of 1 to 2 microns is preferable, but not absolutely necessary. The ink film thickness can be up to about 5 microns thick for certain applications.

While the above describes a sheet fed printing system in which the substrate is a series of cut sheets, the substrate could also form a continuous web. In this case, the multiple impressions are printed on the web.

FIG. 6 illustrates an alternative embodiment of the present invention wherein elements in common with the preceding FIGS. are given like reference numerals. A relief press 62 is identical to relief press 20, except that the inking cylinder 24 of FIG. 4 is omitted and a transfer roller 64 and form rollers 70, 72 are added. In this embodiment, the ink 32 is transferred to the vibrating roller 44 by the method discussed above. The method further includes the step of transferring the ink 32 from the vibrating roller 44 to the transfer rollers 46, 48, and 64 and transferring the ink 32 to the form rollers 50, 52, 70 and 72. The number of transfer rollers and form rollers can be varied depending on the amount of ink 32 to be applied to the substrate 28. The placement of the transfer rollers 46, 48 and 64 and form rollers 50, 52, 70 and 72 with respect to the relief printing plate 26 is also flexible and can be modified in a variety of ways. The method still further includes the step of conveying the ink 32 from the form rollers 50, 52, 70 and 72 to the relief printing plate 26, which prints an image on the substrate 28.

The ink used in the method of the present invention is a high viscosity paste ink comprising a conductive pigment such as a high structure carbon black, a solvent-based vehicle such as an alkyd resin, and a small amount of thinner. The ink can also contain other components such as a drier or Eeonomer® 8000. A preferred drier consists of 1 part Co 12% and 1 part Mn 12%. Eeonomer® 8000, produced by Eeonyx Corporation of Pinole, Calif., is a conductive additive prepared via in-situ polymerization and deposition of intrinsically conductive polymers such as polyaniline or polypyrrole into a carbon black or other matrix. Eeonomer® 8000 tends to improve the release of ink onto the substrate, decreases the amount of tack in the ink and decreases the bridging of traces. The conductive particle size of the ink is between about 0.1 microns and about 0.75 microns, preferably about 0.25 microns.

Carbon black pigments suitable for use in the inks used in the method of the present invention include any of the well known conductive carbon black pigments. These pigments typically are characterized as high structure carbon black, although certain medium structure materials can be used as well. Suitable commercially available carbon blacks include Cabot XC72R, Cabot Black Pearls 2000, Cabot Elftex 5, Columbian Chemicals Company Conductex 975 Ultra and Conductex SC Ultra. While the carbon black can be present in the ink 32 in any amount that provides suitable conductivity, it is preferred to use from about 10 percent by weight of the final composition of the ink to about 37 percent by weight of the final composition of the ink and most preferably to use from about 22 percent by weight of the final composition of the ink to about 27 percent by weight of the final composition of the ink of high structure carbon black.

The ink vehicle used in the paste ink of the present invention functions to properly dispense the pigment and hold the pigment to the substrate after the image is printed on the substrate. Vehicles also affect the viscosity of the ink. With a proper choice of vehicle, the amount of added solvent or thinner can be minimized. Any of the well known and commercially available oil soluble vehicles can be used. Examples of suitable vehicles include modified resin esters, modified hydrocarbon resins and drying oils and alkyds, primarily soya and linseed. A particularly preferred vehicle is an alkyd vehicle, Z-Kyd LSO, available from Kerley Ink of Broadview, Ill. Vehicles are typically used at a level from about 46 percent by weight of the final composition of the ink to about 67 percent by weight of the final composition of the ink.

The thinner is a solvent for the pigment and the vehicle. The purpose of the thinner is to adjust the viscosity of the final ink formulation. Suitable oil soluble thinners are well known to those skilled in the art and include Naptha, e.g., Smooth Lith and Magic Oil (hydrocarbon solvent). The amount of thinner used is more a function of the desired end viscosity. An effective amount of the thinner, if any, should be present to keep the viscosity low enough for good transfer of ink from roller to roller.

One such formulation for a high viscosity conductive paste ink useful in the method of the present invention contains about 22 percent by weight of a high structure carbon black, (Cabot XC72R), about 67 percent by weight of an alkyd resin (Kerley Z-Kyd LSO), about 6 percent by weight of a solvent, namely Van Son Smooth Lith and about 5 percent by weight Eeonomer®.

Another possible formulation for a high viscosity conductive paste of the present invention contains about 23 percent by weight of a high structure carbon black (Cabot XC72R), about 70 percent by weight of an alkyd resin (Kerley Z-Kyd LSO) and about 7 percent by weight of a solvent (Van Son Smooth Lith).

A higher structure carbon black with a lower loading, a lower structure black with a higher loading or a combination of the higher structure carbon and the lower structure carbon blacks can be used.

A carbon-based ink is preferred, but any conductive pigment can be used in the ink such as silver, aluminum, gold, nickel, copper, conductive polymers, combinations thereof or other known conductive materials. One such formulation using alternate conductive pigments contains about 82 percent by weight silver (Silflake 151, manufactured by Technic Inc., of Woonsocket, R.I.), about 16 percent by weight of an alkyd resin (Kerley Z-Kyd LSO) and about 2 percent high structure carbon black (Cabot XC72R).

There are many advantages of the present invention as described in detail above. The relief press and the ink composition allow printing of traces with a gap of less than about 40 microns between adjacent traces with the preferred gap size being about 20 microns, although gap widths smaller than 20 microns are achievable. Traces of less than about 40 microns in width, and preferably less than about 20 microns in width, can also be achieved by the method and apparatus of the present invention. Although the gap and trace widths are smaller than in normal conductive ink printing methods, the conductivity of the ink is not compromised. The conductivity and resistivity of small traces is consistent with that of larger, wider traces. Sufficient conductivity is obtained by the combination of relief printing and a high viscosity ink that has a high structure carbon content.

Depending on the substrate used and the particular characteristics of the ink, the method of the present invention will produce printed conductors with a surface resistivity of up to about 1000 kΩ per square. Carbon-based inks printed by the method and apparatus of the present invention produce a surface resistivity from about 1 kΩ per square to about 1000 kΩ per square, but on paper, it is preferred that the surface resistivity be from about 1 kΩ per square to about 50 kΩ per square. Silver-based inks printed by the method of the present invention produce a surface resistivity that can also be less than 1 kΩ per square.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

We claim:

1. A method of printing using an electrically conductive ink, the method comprising the steps of:
providing a supply of the electrically conductive ink;
providing a relief printing plate having a desired printing pattern formed thereon, wherein the pattern includes two adjacent traces having a gap between the adjacent traces of less than about 40 microns;
applying a controlled quantity of the electrically conductive ink to the relief printing plate; and
contacting the relief printing plate to a substrate to create an impression on the substrate.

2. The method of claim 1, wherein the ink has a film thickness of less than about 5 microns on the substrate.

3. The method of claim 1, wherein the applying step includes multiple applications of the ink by the same roller of less than 5 microns thickness to the relief printing plate between each contacting step.

4. The method of claim 1, wherein the applying step includes multiple applications of the ink by several different rollers of less than 5 microns thickness to the relief printing plate between each contacting step.

5. The method of claim 3, wherein the relief plate receives two or more applications of the ink.

6. The method of claim 4, wherein the relief plate receives two or more applications of the ink.

7. The method of claim 1, wherein the ink comprises a conductive pigment and a vehicle.

8. The method of claim 7, wherein the ink also comprises a thinner.

9. The method of claim 8, wherein the ink comprises from about 10 to about 37 percent of the conductive pigment, from about 46 to about 67 percent of the vehicle and an effective amount of the thinner to adjust the viscosity to enable proper transfer of the ink from roller to roller.

10. The method of claim 8, wherein the conductive pigment is a carbon black and the vehicle is an alkyd resin.

11. The method of claim 9, wherein the conductive pigment is a carbon black and the vehicle is an alkyd resin.

12. The method of claim 8, wherein the ink also includes a drier.

13. The method of claim 1, wherein the gap between adjacent traces is less than about 20 microns.

14. The method of claim 1, wherein the pattern includes at least one trace having a width of less than about 40 microns.

15. The method of claim 11, wherein the pattern includes at least one trace having a width of less than about 20 microns.

16. The method of claim 1, wherein a dried film of the conductive ink has a surface resistivity less than about 1000 kΩ per square.

17. A method of printing using an electrically conductive ink, the method comprising the steps of:
providing a supply of the electrically conductive ink;
providing a relief printing plate having a desired printing pattern formed thereon, wherein the pattern includes two adjacent traces having a gap between the adjacent traces of less than about 40 microns and wherein the pattern includes at least one trace having a width of less than about 40 microns;
applying a controlled quantity of the electrically conductive ink to the relief printing plate; and
contacting the relief printing plate to a substrate at a print speed of greater than about 3,000 impressions per hour.

18. The method of claim 17, wherein the ink has a film thickness of less than about 5 microns on the substrate.

19. The method of claim 17, wherein the applying step includes multiple applications of the ink by the same roller of less than 5 microns thickness to the relief printing plate between each contacting step.

20. The method of claim 17, wherein the applying step includes multiple applications of the ink by several different rollers of less than 5 microns thickness to the relief printing plate between each contacting step.

21. The method of claim 19, wherein the relief plate receives two or more applications of the ink.

22. The method of claim 20, wherein the relief plate receives two or more applications of the ink.

23. The method of claim 17, wherein the ink comprises a conductive pigment and a vehicle.

24. The method of claim 23, wherein the ink also comprises a thinner.

25. The method of claim 24, wherein the ink comprises from about 10 to about 37 percent of the conductive pigment, from about 46 to about 67 percent of the vehicle and an effective amount of the thinner to adjust the viscosity to enable proper transfer of the ink from roller to roller.

26. The method of claim 24, wherein the conductive pigment is a high structure carbon black and the vehicle is an alkyd resin.

27. The method of claim 25, wherein the conductive pigment is a high structure carbon black and the vehicle is an alkyd resin.

28. The method of claim 24, wherein the ink also includes a drier.

29. The method of claim 17, wherein the gap between adjacent traces is less than about 20 microns.

30. The method of claim 17, wherein the pattern includes at least one trace with a width of less than about 20 microns.

31. The method of claim 17, wherein a dried film of the conductive ink has a surface resistivity less than about 1000 kΩ per square.

32. Apparatus for printing an electrically conductive ink, comprising:
a relief printing plate having a desired printing pattern formed thereon, wherein the pattern includes two adjacent traces having a gap between the adjacent traces of less than about 40 microns; and
an ink train that applies a controlled quantity of the electrically conductive ink to the relief printing plate, wherein the relief printing plate contacts a substrate to create an impression on the substrate.

33. The apparatus of claim 32, wherein the ink has a film thickness of less than about 5 microns on the substrate.

34. The apparatus of claim 32, wherein the relief printing plate repetitively contacts the substrate and wherein the ink train applies ink multiple times to the relief printing plate between each contact of the relief printing plate to the substrate.

35. The apparatus of claim 34, wherein the ink train includes first and second different rollers wherein each roller applies ink to the relief printing plate between each contact of the relief printing plate to the substrate.

36. The apparatus of claim 34, wherein the ink train includes a roller that applies ink multiple times to the relief printing plate between each contact of the relief printing plate to the substrate.

37. The apparatus of claim 32, wherein the ink comprises a conductive pigment and a vehicle.

38. The apparatus of claim 37, wherein the ink also comprises a thinner.

39. The apparatus of claim 38, wherein the ink comprises from about 10 to about 37 percent of the conductive pigment, from about 46 to about 67 percent of the vehicle and an effective amount of the thinner to adjust the viscosity to enable proper transfer of the ink from roller to roller.

40. The apparatus of claim 39, wherein the conductive pigment is a carbon black and the vehicle is an alkyd resin.

41. The apparatus of claim 37, wherein the conductive pigment is a carbon black and the vehicle is an alkyd resin.

42. The apparatus of claim 37, wherein the ink also includes a drier.

43. The apparatus of claim 32, wherein the gap between adjacent traces is less than about 20 microns.

44. The apparatus of claim 32, wherein the pattern includes at least one trace having a width of less than about 40 microns.

45. The apparatus of claim 32, wherein the pattern includes at least one trace having a width of less than about 20 microns.

46. The apparatus of claim 32, wherein a dried film of the conductive ink has a surface resistivity less than about 1000 kΩ per square.
